(19) United States
(12) Patent Application Publication
(10) Pub. No.: US 2017/0076247 A1
(43) Pub. Date: Mar. 16, 2017

(54) WORK MANAGEMENT WITH CLAIMS CACHING AND DYNAMIC WORK ALLOCATION

(71) Applicant: Bank of America Corporation, Charlotte, NC (US)

(72) Inventors: Kevin Mayes, West Grove, PA (US); Jerome George Recker, Lansing, MI (US); Daniel Wesley Kenemer, DeWitt, MI (US); Sreekanth Ram, Newark, DE (US); David Chmielewski, Charlotte, MI (US); Jonathan James Lindsey, Eaton Rapids, MI (US)

(21) Appl. No.: 14/853,590

(22) Filed: Sep. 14, 2015

(51) Int. Cl. G06Q 10/06; G06F 3/0484; G06F 3/0486

(52) U.S. Cl. CPC G06Q 10/063118; G06F 3/0486; G06F 3/04842

(57) ABSTRACT

A work management system for claims work management by claims caching and dynamic work allocation has a module configured to cause the processor to receive the plurality of claims from the plurality of claims input channels; determine the type and priority of each of the received plurality of claims; determine a profile of work for one or more claims based on the determined type and priority of each of the one or more claims; create a plurality of claims cache tables based on the profiles of work, each cache table comprising one or more of the plurality of claims; and in automatic response to determining the profile of work for the one or more claims, dynamically allocating each of the plurality of claims to at least one group and at least one user within the at least one group.

### FIELD

In general, embodiments of the invention relate to management of claims workflows and, more particularly, a centralized claims work management system that provides for prioritizing and allocating work to various groups and users.

### BACKGROUND

In large enterprise businesses, such as financial institutions or the like, implementing new workflows (i.e., automated or manual procedures/processes conducted by the enterprise) or making changes to existing workflows can be a daunting task. This is because most of the workflows that are conducted within a large enterprise have upstream and/or downstream dependent workflows that are affected by changes to existing workflows and/or addition/deletion of workflows. In addition, most of the workflows within a large enterprise have internal rules and regulations, as well as, in some instances government standards and regulations which must be abided by when conducting the workflow and/or when making changes to the workflow. In specific instances, a change/edit to one workflow may be prohibited due to the change's effect on a downstream dependent workflow (e.g., the downstream workflow would no longer comply to internal rules/regulations and/or government standards or regulations) or a change/edit to one workflow may be acceptable but result in the noncompliance of one or more upstream dependent workflows. Moreover, workflow changes typically require various degrees of corporate approval (i.e., chains of approval) to effectuate the change, with chains of approval existing within each upstream and downstream dependent workflow. Even with the advent of automated systems for workflow management, the management of workflow changes in large enterprises is an exhaustive and time-consuming task.

In addition, in large enterprises many disparate workflow systems or platforms are implemented. Each of these workflow platforms may provide for a different format for hosting the workflows (e.g., standard markup language, such as HTML (HyperText Markup Language); a diagramming and vectors management application; or the like). The disparate formats of such workflow platforms provide an obstacle in importing and exporting workflows or portions of workflows from one workflow platform/system to another workflow platform/system. In most instances, no means exist to interchangeably move a workflow or a portion of a workflow from one platform/system to another/platform system without a redesign of the workflow to accommodate the format of the platform/system receiving the workflow.

Therefore, a need exists to develop systems, apparatus, computer program products, methods and the like that provide for a centralized workflow management system that provides for the ability to manage most, if not all, of the workflows existing throughout a large enterprise regardless of the format of the workflow platform/system providing the workflows. The desired systems and the like should provide for workflow extensibility, such that changes to existing workflows and/or addition of new workflows result in automatic adaption to all downstream and upstream workflows that are affected by the change or addition. Moreover, the desired systems and the like should provide for workflow extendibility, such that additions can be made to existing workflows.

### SUMMARY OF THE INVENTION

The following presents a simplified summary of one or more embodiments in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address the above needs and/or achieve other advantages by providing apparatus, systems, computer program products, methods or the like for claims work management by claims caching and dynamic work allocation According to embodiments, an apparatus includes a computing platform having a memory and at least one processor in communication with the memory; a plurality of claims input channels each configured to communicate one or more of a plurality of claims of varying types and priorities; a centralized claims work management module stored in the memory, executable by the processor, and configured to cause the processor to receive the plurality of claims from the plurality of claims input channels; determine the type and priority of each of the received plurality of claims; determine a profile of work for one or more claims based on the determined type and priority of each of the one or more claims; and in automatic response to determining the profile of work for the one or more claims, dynamically allocating each of the plurality of claims to at least one group and at least one user within the at least one group.

In some embodiments, the centralized claims work management module is further configured to cause the processor to create a plurality of claims cache tables based on the profiles of work, each cache table comprising one or more of the plurality of claims; and wherein dynamically allocating each of the plurality of claims comprises assigning each cache table and its one or more claims to at least one group and at least one user within the at least one group.

In some embodiments, the centralized claims work management module is further configured to cause the processor to access one or more work allocation rules; and wherein dynamically allocating is based at least in part on the accessed work allocation rules. In some such embodiments, the centralized claims work management module is further configured to cause the processor to receive a request from a user to update one or more of the claims cache tables; and in response to receiving the request, updating the claims cache tables, thereby resulting in one or more prioritized claims being processed with little or no latency. In other such embodiments, the centralized claims work management module is further configured to cause the processor to lock one or more of the claims cache tables so that no modifications of the claims in the one or more claims cache tables is allowed. In other such embodiments, the centralized claims work management module is further configured to cause the processor to lock assignment of at least one of the claims cache tables to (1) its assigned at least one group, or (2) its assigned at least one user.

In some such embodiments, the centralized claims work management module is further configured to cause the processor to cause presentation of a manager interface comprising a queue of workflow management with drag and drop functionality. In some such embodiments, the manager interface is configured to enable a manager of claims work to reallocate, in real-time, one or more of the allocated plurality of claims. In other such embodiments, the manager interface is configured to enable a manager of claims work to change (1) a priority associated with one or more claims, or (2) a priority associated with one or more profiles of work; and the centralized claims work management module is further configured to cause the processor to dynamically reallocate, in automatic response to the manager interface receiving manager input changing (1) a priority associated with one or more claims, or (2) a priority associated with one or more profiles of work, one or more of the allocated plurality of claims based at least in part on the manager input.

According to embodiments of the invention, a method includes receiving, by a processor of a computing platform executing a centralized claims work management module stored in a memory of the computing platform, a plurality of claims from a plurality of claims input channels each configured to communicate one or more of the plurality of claims of varying types and priorities; determining, by the processor executing the centralized claims work management module, the type and priority of each of the received plurality of claims; determining, by the processor executing the centralized claims work management module, a profile of work for one or more claims based on the determined type and priority of each of the one or more claims; and in automatic response to determining the profile of work for the one or more claims, dynamically allocating, by the processor executing the centralized claims work management module, each of the plurality of claims to at least one group and at least one user within the at least one group.

In some embodiments, the method includes creating, by the processor executing the centralized claims work management module, a plurality of claims cache tables based on the profiles of work, each cache table comprising one or more of the plurality of claims; and wherein dynamically allocating each of the plurality of claims comprises assigning each cache table and its one or more claims to at least one group and at least one user within the at least one group.

In some such embodiments, the method includes accessing, by the processor executing the centralized claims work management module, one or more work allocation rules; and wherein dynamically allocating is based at least in part on the accessed work allocation rules. In other such embodiments, the method includes receiving a request from a user to update one or more of the claims cache tables; and in response to receiving the request, updating the claims cache tables, thereby resulting in one or more prioritized claims being processed with little or no latency. In other such embodiments, the method includes locking, by the processor executing the centralized claims work management module, one or more of the claims cache tables so that no modifications of the claims in the one or more claims cache tables is allowed. In other such embodiments, the method includes locking, by the processor executing the centralized claims work management module, assignment of at least one of the claims cache tables to (1) its assigned at least one group, or (2) its assigned at least one user.

In some embodiments, the method includes causing presentation, by the processor executing the centralized claims work management module, of a manager interface comprising a queue of workflow management with drag and drop functionality. In some such embodiments, the manager interface is configured to enable a manager of claims work to reallocate, in real-time, one or more of the allocated plurality of claims. In other such embodiments, the manager interface is configured to enable a manager of claims work to change (1) a priority associated with one or more claims, or (2) a priority associated with one or more profiles of work; the method further comprising dynamically reallocating, by the processor executing the centralized claims work management module and in automatic response to the manager interface receiving manager input changing (1) a priority associated with one or more claims, or (2) a priority associated with one or more profiles of work, one or more of the allocated plurality of claims based at least in part on the manager input.

According to embodiments of the invention, a computer program product includes a non-transitory computer-readable medium comprising a first set of codes for causing a computer to receive a plurality of claims from the a plurality of claims input channels; a second set of codes for causing a computer to determine the type and priority of each of the received plurality of claims; a third set of codes for causing a computer to determine a profile of work for one or more claims based on the determined type and priority of each of the one or more claims; and a fourth set of codes for causing a computer to, in automatic response to determining the profile of work for the one or more claims, dynamically allocate each of the plurality of claims to at least one group and at least one user within the at least one group.

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, which are not necessarily drawn to scale, and wherein:

FIG. 1 provides a schematic diagram of a system for enterprise-wide service delivery including centralized workflow management, in accordance with embodiments of the present invention;

FIG. 2 provides a schematic diagram of an environment in which systems discussed herein operate, in accordance with embodiments of the present invention;

FIG. 3 provides a flowchart of a method for claims work management, in accordance with embodiments of the present invention; and

FIGS. 4A-4T provide representations of screenshots of a user interface running on a user system, in accordance with embodiments of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout. Although some embodiments of the invention described herein are generally described as involving a “financial institution,” one of ordinary skill in the art will appreciate that the invention may be utilized by other businesses that take the place of or work in conjunction with financial institutions to perform one or more of the processes or steps described herein as being performed by a financial institution.

As will be appreciated by one of skill in the art in view of this disclosure, the present invention may be embodied as an apparatus (e.g., a system, computer program product, and/or other device), a method, or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product comprising a computer-usable storage medium having computer-usable program code/computer-readable instructions embodied in the medium.

Any suitable computer-usable or computer-readable medium may be utilized. The computer usable or computer readable medium may be, for example but not limited to, an electronic, magnetic, optical, electromagnetic, infrared, or semiconductor system, apparatus, or device. More specific examples (e.g., a non-exhaustive list) of the computer-readable medium would include the following: an electrical connection having one or more wires; a tangible medium such as a portable computer diskette, a hard disk, a time-dependent access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted or unscripted programming language such as Java, Perl, Smalltalk, C++ or the like. However, the computer program code/computer-readable instructions for carrying out operations of the invention may also be written in conventional procedural programming languages, such as the “C” programming language or similar programming languages.

Embodiments of the present invention are described below with reference to flowchart illustrations and/or block diagrams of methods or apparatuses (the term “apparatus” including systems and computer program products). It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute by the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

According to embodiments of the invention described herein, various systems, apparatus, methods, and computer program products are herein described for a centralized system for workflow management. The centralized nature of the system provides for the ability to manage all of the workflows existing through a large enterprise regardless of the format of the workflow platform/system providing the workflows, the protocols used to communicate within the platforms/systems and/or the hardware/servers on which the workflow platforms reside.

Embodiments of the invention provide a claims work management system that intakes claims being of different types and priority for processing. Integrated with the system are work management tools to prioritize and allocate work to various groups and users. The system creates different cache tables based on profiles of the work for assignment to groups and users. The cache tables may be generated from the overall claims database and then assigned based on work allocation rules to groups and individual users. The cache data tables may be static or updated on request to ensure prioritized claims are processed with little to no latency. The system allows for on-demand work allocations and dashboards regarding claims processing.

In some cases, embodiments of the system allow for creation of group and user profiles and designation of claim types to the groups and individual users. During operation, the system allows managers to reassign/prioritize claim types for processing by individual groups or users dynamically during claims processing.

In some embodiments, the centralized workflow management system herein described provides for existing workflows to be changed/edited, new workflows to added and/or obsolete workflows to be deleted and, as a result of such changes/additions/deletions, automatic adaption occurs within all downstream and upstream workflows that are affected by the change or addition.

Further embodiments of the invention provide for non-compliant (i.e., internal noncompliance and/or external noncompliance) or invalid/obsolete workflows to be identified and act as triggers for automatic generation of new workflows or changes to existing workflows.

Additionally, embodiments of the invention provide for both pre-checks and self-checks to insure the viability of making automated changes to dependent workflows. Pre-checks occur prior to implementing a new or edited workflow and self-checks occur prior to adapting a downstream or upstream dependent workflow. As a result of the pre-checks and/or self-checks failure points may be identified in the chain dependency or the like which prohibit workflows from being implemented or weak control points may be identified which may not prohibit workflows from being implemented but identify weakened controls (e.g., unnecessary day exchanges, redundant data exchanges or the like). Identification of failure points, weak control pints or other pre-check and/or self-check results may be automatically communicated to designated administrators in the form of an alert or the like.

As mentioned above, in additional embodiments of the invention, the claims work management module herein described provides for a Graphical User Interface (GUI) in which a user can create new workflows, edit existing workflows and the like by drag and drop commands, cut and paste commands or the like.

In summary, various embodiments of the invention provide an integrated claims management and work assignment/priority schedule tool that uses claims data designation to establish user profile and user-specific work queues. Embodiments provide features such as dynamic (real time) assignment of work based on manager selection, and cached data tables for associated/assigned to individual groups and/or users. The system enables an ability to refresh and reassign workflows with little to no latency. In some cases, embodiments provide for manager and individualized queue management of work flow including drag and drop functionality over a manager interface that can also be used to create individual user profiles for group members and make alterations to such user profiles. Embodiments further provide for on the fly reallocation of level importance/work flow priority.

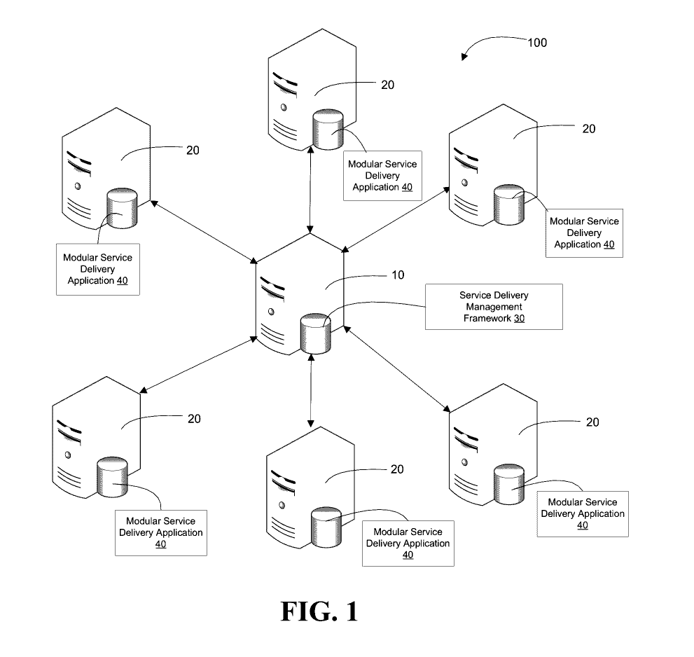

Referring to FIG. 1, a schematic diagram is provided of a system 100 for providing technology/OS-agnostic and protocol-agnostic delivery of services within an enterprise, in accordance with embodiments of the present invention. One of the services that may be delivered by system 100 is the claims work management module herein described at length below. In some embodiments, the system 100 is configured as a hub-and-spoke model, in which the hub server 10 provides for management of the service delivery system via service delivery management framework 30 and the spoke servers 20, implemented throughout the enterprise, are deployed with a modular service delivery application 40.

The spoke servers 20 may be one or more systems or servers and may constitute or include one or more claims input channels configured to consolidate claims associated with one or more groups and/or one or more individual users so that they may be communicated to the hub server 10.

The service delivery application 40 is an open-source-based web services application and, as such, can be deployed and/or executed on any type of server (technology-agnostic) executing any type of operating system (OS-agnostic). The modular nature of the application means that the service delivery system is extensible; as additional services are added new modules within the application 40 may be added/plugged-in into the application 40. As such, the present invention provides a holistic approach to service delivery that results in an enterprise-wide solution for service delivery.

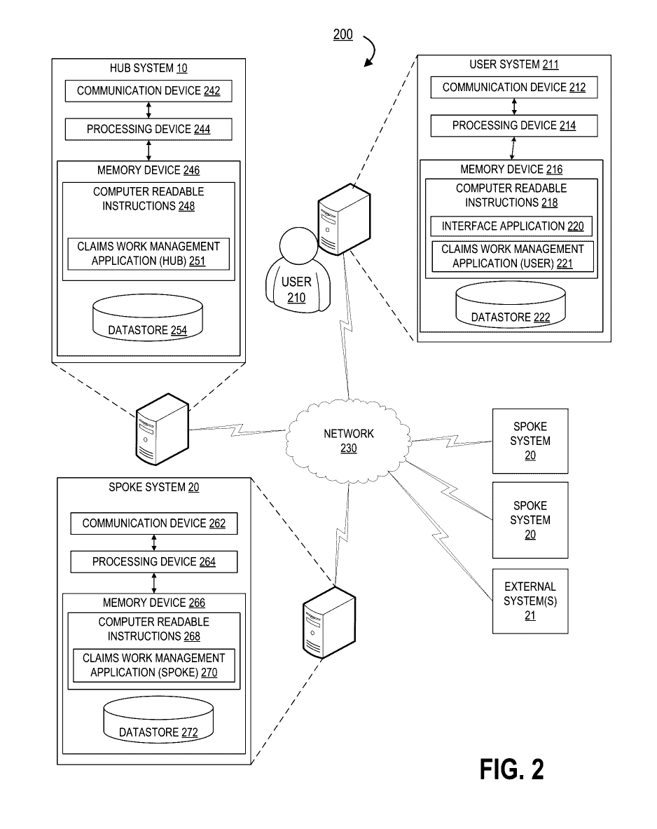

In specific embodiments of the invention, the service delivery application 40 includes a workflow management module (shown and described in FIG. 2) that is configured to provide protocol-agnostic, format-agnostic workflow management throughout the enterprise. In some embodiments, the workflow management module is configured as an open source application that is protocol-agnostic, and therefore deployment and use of workflow management throughout most, if not all, of the enterprise's servers eliminates the need to deploy, maintain and configure compatibility amongst multiple different protocol-specific workflow management systems or provide for manual workflow redesign in the event of format or protocol differences.

Service delivery application 40 provides uniform management for all of the services delivered by service delivery application 40. In this regard, service delivery application 40 includes core services that act as a unifier to provide umbrella-like management over security, governance (approvals and exceptions), provisioning (new modules and revisions to modules), auditing, tracking, reporting and the like. Such uniformity in management provides efficiency and eliminates the need to resolve conflicts that arise in disparate applications having distinct security, governance, provisioning protocols, rules and regulations.

Referring now to FIG. 2, an environment 200 in which a hub system 240 and multiple spoke systems 20 operate is illustrated, in accordance with some embodiments of the invention. The environment 200 includes a user system 211 associated or used with authorization of a user 210 (e.g., an associate, a manager, a vendor or the like), a hub system 10 and multiple spoke systems 20. In some embodiments, one or more of the spoke systems 20 are external systems 21, which may be maintained or managed by third party entities.

The systems and devices communicate with one another over the network 230 and perform one or more of the various steps and/or methods according to embodiments of the disclosure discussed herein. The network 230 may include a local area network (LAN), a wide area network (WAN), and/or a global area network (GAN). The network 230 may provide for wireline, wireless, or a combination of wireline and wireless communication between devices in the network. In one embodiment, the network 230 includes the Internet.

The user system 211, the hub system 10 and the spoke systems 20 each include a computer system, server, multiple computer systems and/or servers or the like. The hub system 10, in the embodiments shown has a communication device 242 communicably coupled with a processing device 244, which is also communicably coupled with a memory device 246. The processing device 244 is configured to control the communication device 242 such that the hub system 10 communicates across the network 230 with one or more other systems. The processing device 244 is also configured to access the memory device 246 in order to read the computer readable instructions 248, which in some embodiments includes one or more claims work management applications 251 or modules, which may or may not be the same as applications and/or modules running on the user system 211 and/or the spoke systems 20. The memory device 246 also includes a datastore 254 or database for storing pieces of data that can be accessed by the processing device 244. In some embodiments, the datastore 254 includes a claims data repository.

As used herein, a “processing device,” generally refers to a device or combination of devices having circuitry used for implementing the communication and/or logic functions of a particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device 214, 244, or 264 may further include functionality to operate one or more software programs based on computer-executable program code thereof, which may be stored in a memory. As the phrase is used herein, a processing device 214, 244, or 264 may be “configured to” perform a certain function in a variety of ways, including, for example, by having one or more general-purpose circuits perform the function by executing particular computer-executable program code embodied in computer-readable medium, and/or by having one or more application-specific circuits perform the function.

Furthermore, as used herein, a “memory device” generally refers to a device or combination of devices that store one or more forms of computer-readable media and/or computer-executable program code/instructions. Computer-readable media is defined in greater detail below. For example, in one embodiment, the memory device 246 includes any computer memory that provides an actual or virtual space to temporarily or permanently store data and/or commands provided to the processing device 244 when it carries out its functions described herein.

In some embodiments, workflow data or other data such as work assignments, associate or worker profiles and the like may be stored in a non-volatile memory distinct from instructions for executing one or more process steps discussed herein that may be stored in a volatile memory such as a memory directly connected or directly in communication with a processing device executing the instructions. In this regard, some or all the process steps carried out by the processing device may be executed in near-real-time, thereby increasing the efficiency by which the processing device may execute the instructions as compared to a situation where one or more of the instructions are stored and executed from a non-volatile memory, which may require greater access time than a directly connected volatile memory source. In some embodiments, one or more of the instructions are stored in a non-volatile memory and are accessed and temporarily stored (i.e., buffered) in a volatile memory directly connected with the processing device where they are executed by the processing device. Thus, in various embodiments discussed herein, the memory or memory device of a system or device may refer to one or more non-volatile memory devices and/or one or more volatile memory devices.

The user system 211 includes a communication device 212 and an image capture device 215 (e.g., a camera) communicably coupled with a processing device 214, which is also communicably coupled with a memory device 216. The processing device 214 is configured to control the communication device 212 such that the user system 211 communicates across the network 230 with one or more other systems. The processing device 214 is also configured to access the memory device 216 in order to read the computer readable instructions 218, which in some embodiments includes an interface application 220 and a claims works management application 221. The memory device 216 also includes a datastore 222 or database for storing pieces of data that can be accessed by the processing device 214.

The spoke system 20 includes a communication device 262 and an image capture device (not shown) communicably coupled with a processing device 264, which is also communicably coupled with a memory device 266. The processing device 264 is configured to control the communication device 262 such that the spoke system 20 communicates across the network 230 with one or more other systems. The processing device 264 is also configured to access the memory device 266 in order to read the computer readable instructions 268, which in some embodiments includes a claims work management application 270. The memory device 266 also includes a datastore 272 or database for storing pieces of data that can be accessed by the processing device 264.

In some embodiments, the claims work management application (hub) 251, the claims works management application (user) 221 and the claims work management application (spoke) 270 interact with one another to implement the process steps described herein.

The applications 220, 221, 251, and 270 are for instructing the processing devices 214, 244 and 264 to perform various steps of the methods discussed herein, and/or other steps and/or similar steps. In various embodiments, one or more of the applications 220, 221, 251, and 270 are included in the computer readable instructions stored in a memory device of one or more systems or devices other than the systems 10, 20 and 211. For example, in some embodiments, the application 220 is stored and configured for being accessed by a processing device of one or more external systems 21 connected to the network 230. In various embodiments, the applications 220, 221, 251, and 270 stored and executed by different systems/devices are different. In some embodiments, the applications 220, 221, 251, and 270 stored and executed by different systems may be similar and may be configured to communicate with one another, and in some embodiments, the applications 220, 221, 251, and 270 may be considered to be working together as a singular application despite being stored and executed on different systems.

In various embodiments, one of the systems discussed above, such as the hub system 10, is more than one system and the various components of the system are not collocated, and in various embodiments, there are multiple components performing the functions indicated herein as a single device. For example, in one embodiment, multiple processing devices perform the functions of the processing device 244 of the hub system 10 described herein. In various embodiments, the hub system 10 includes one or more of the external systems 21 and/or any other system or component used in conjunction with or to perform any of the method steps discussed herein.

In various embodiments, the hub system 10, the spoke system 20, and the user system 211 and/or other systems may perform all or part of one or more method steps discussed above and/or other method steps in association with the method steps discussed above. Furthermore, some or all the systems/devices discussed here, in association with other systems or without association with other systems, in association with steps being performed manually or without steps being performed manually, may perform one or more of the steps of method 300, the other methods discussed below, or other methods, processes or steps discussed herein or not discussed herein.

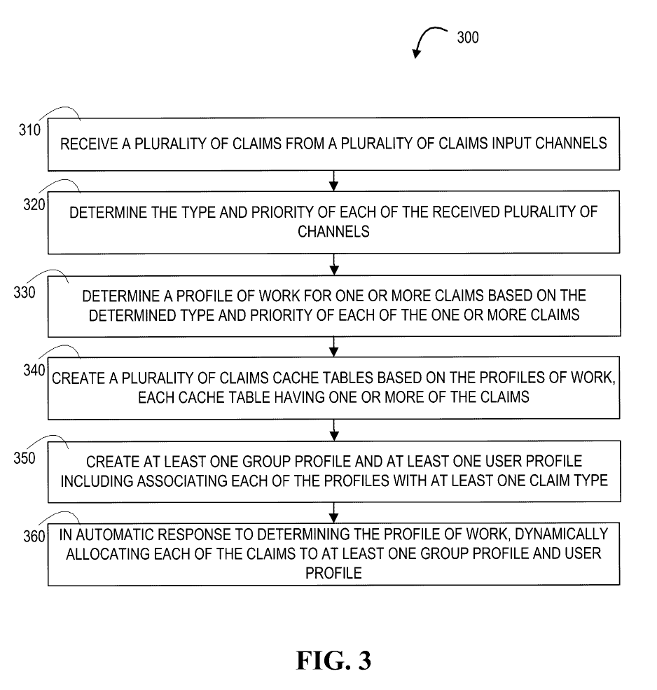

Referring now to FIG. 3, a flowchart illustrates a method 300 for claims work management with claims caching, claims priorities and assignment and dynamic work allocation according to embodiments of the invention. The first step, as represented by block 310 is to receive a plurality of claims from a plurality of claims input channels. The claims input channels are represented in FIGS. 1 and 2 by the spoke systems 20 and their connections with the hub system 10. In various embodiments, only one channel is used. In some cases, more than one channel is used. In some cases, only those channels with relevant information are used. This may be determined based on user input or based on communications from spoke control systems such as a business group's server sending instructions to the hub system to configure and/or activate a communication channel with a spoke system so that relevant information may be communicated across the channel. In some cases, when the spoke control system detects that new information or otherwise relevant information may be available at one or more spoke systems, the spoke control system sends control signals that cause the hub system to establish a dedicated communication channel between the hub system and the one or more spoke systems that may have relevant information. In some cases, the dedicated communication channel is optimized so that the information may be communicated more efficiently than is could be over a non-dedicated communication channel. For example, a non-dedicated communication channel may utilize insecure network connections or systems or may utilize unstable or noise-prone network connections or systems. Thus, when establishing a dedicated communication channel, the hub system may optimize parameters of the dedicated communication channel such that the communication channel is less prone to interruption from security breach, other traffic, offline systems or the like. This may be done by, for example, designating certain systems on the network between the hub system and the various spoke systems, respectively, as low-functioning, medium-functioning, or high-functioning network systems/hubs/connections/channels (collectively referred to as network systems). In various other embodiments, the number of categories of systems may be raised or lowered. For example, there may be five (5) distinct categories of systems. The various network systems may be categorized by one or more administrators and/or automatically based on one or more monitoring modules or applications running on the hub and/or spoke systems. Such a monitoring system may flag any abnormalities in network communication such as an unintended offline network system, a security breach of a network system, a network communication affected negatively by noise or interference (in some cases based on a predetermined threshold of interference or communication errors). Thus, once various network systems are categorized, the spoke control systems and/or the hub system may optimize the dedicated communication channel by selecting appropriately categorized network systems for the communication channel. For example, the hub system may establish a dedicated communication channel in order to receive information associated with high priority work (as indicated by a spoke control system, for example, in its control signals to the hub system). When establishing the dedicated communication channel, the hub system may only select high-functioning network systems in order to ensure that the high priority information may be reliably communicated from the spoke system(s) to the hub system. In another example, certain spoke systems are designated or categorized and always provided a dedicated (or non-dedicated) communication channel based on their respective categorization.

The next step, as represented by block 320, is to determine the type and priority of each of the received plurality of claims from the plurality of channels. In different embodiments, this can be done in a variety of ways. For example, in some cases, each of the plurality of claims is accompanied by information indicating its type and/or priority from the spoke system(s). In some instances, each of the claims is categorized into a type category, and in some instances, each of the claims is categorized into a priority category. In some cases, the type and priority are synonymous, for example, in a situation where all claims of a particular type are necessarily of a particular category. In some embodiments, each type category may have a specific identifier that accompanies the claims that are part of that type category. Alternatively, each of the claims that is communicated from a particular spoke system may be a particular type or priority. For example, all claims communicated from Spoke System A have type C and priority Z, whereas all claims communicated from Spoke System B have type A and priority X. In some embodiments, each priority category may have a specific identifier that accompanies the claims that are part of that priority category. The type may refer to any of one or more characteristics of the claims, for example, the type may refer to the line(s) of business and/or products associated with a particular claim or group of claims. The priority may be based on the type of the claim as indicated above, or may be manually set and/or adjusted based on a manager's preferences. For example, a manager of claim mitigation associates may, through use of the manager interface discussed elsewhere herein, may specify that a claim or a group of claims are of a particular priority. For example, a claim or group of claims may be assigned a priority of ten (10) out of ten (10), which would indicate the highest available priority, whereas another claim may be assigned a priority of five (5), which would indicate a medium level priority and yet another claim may be assigned a priority of one (1), which would indicate a low level priority. The priorities associated with a claim or group of claims may be used, as discussed elsewhere herein, to rank the claims for work in a workgroup or on a particular associate's docket or profile of work.

The next step, as represented by block 330, is to determine a profile of work for one or more claims based on the determined type and priority of each of the one or more claims. The profile of work for a particular claim, in some embodiments, represents to which workgroup the claim should be assigned, the priority with which the claim should be addressed and/or other information relevant to the claims and in some cases, necessary to process the claim. In some cases, the profile of work also includes a specific associate to which the claim should be or is assigned, and in some cases, the profile of work indicates a secondary, tertiary or other associate to which a claim should be assigned in case the original or primary associate is unavailable to complete the work.

Next, as represented by block 340, the system creates a plurality of claims cache tables based on the profiles of work. Each cache table has one or more of the claims associated with it. One or more of the claims cache tables may be stored in one or more non-volatile memory locations in the case where the cache tables are not expected to be needed for very quick access. In other cases, one or more cache tables may be stored in volatile memory devices so that they may be provided to the processing device very quickly for near-real-time access and processing.

Next, as represented by block 350, the system creates at least one group profile and at least one user profile. It then associates each of the profiles with at least one claim type. The group profile may be based on a business' organizational structure. For example, all of the associates assigned to a line of business within an enterprise may be part of a particular group profile. The group profile may include characteristics regarding the group. For example, the work assigned to the group may be defined by the group profile, and characteristics regarding individual associate work assignments and/or priorities of work associated with the group of the group profile may be included in the group profile. The user profile may include information about the user or associate such as the associate's level of experience, type of work performed, and the like. The user and/or the group profile may also include some of all the information contained in other profiles such as a group profile including all the user profiles of the users within the group. In some cases, a user profile includes some of all the information of its associated group profile.

Finally, as represented by block 360, in automatic response to determining the profile of work, the system dynamically allocates each of the claims to at least one group profile and user profile.

In some embodiments, one or more allocation rules are accessed and used to dynamically allocate each of the plurality of claims to the groups, users, group profiles, and/or user profiles. The allocation rules may be created or changed by an administrator of the system so that certain types of claims, priorities of claims, groups, users, etc. may be rearranged in the ways the systems allocates work. For example, an administrator may change the rules so that only certain groups are able to receive work of a particularly high priority.

In some cases, a user requests an update of one or more of the claims cache tables, and in response to receiving the request, the system updates the claims cache tables, thereby resulting in one or more prioritized claims being processed with little or no latency.

In other cases, the system may lock one or more of the claims cache tables so that modifications of the claims in one or more claims cache tables is not allowed. In other cases, the system may lock assignment of at least one of the claims cache tables to (1) its assigned group and/or (2) its assigned user.

In some cases, the system can cause presentation of a manager interface (as discussed further below), where the manager interface may include a queue of workflow management with drag and drop functionality. In some such cases, the manager interface is configured to enable a manager of claims work to reallocate, in real-time, one or more of the allocated plurality of claims. In other such cases, the manager interface may be configured to enable a manager of claims work to change (1) a priority associated with one or more claims and/or (2) a priority associated with one or more profiles of work. In some cases, the system is configured to dynamically reallocate, in automated response to the manager interface receiving manager input changing (1) a priority associated with one or more claims and/or (2) a priority associated with one or more profiles of work, one or more of the allocated plurality of claims based at least in part on the manager input.

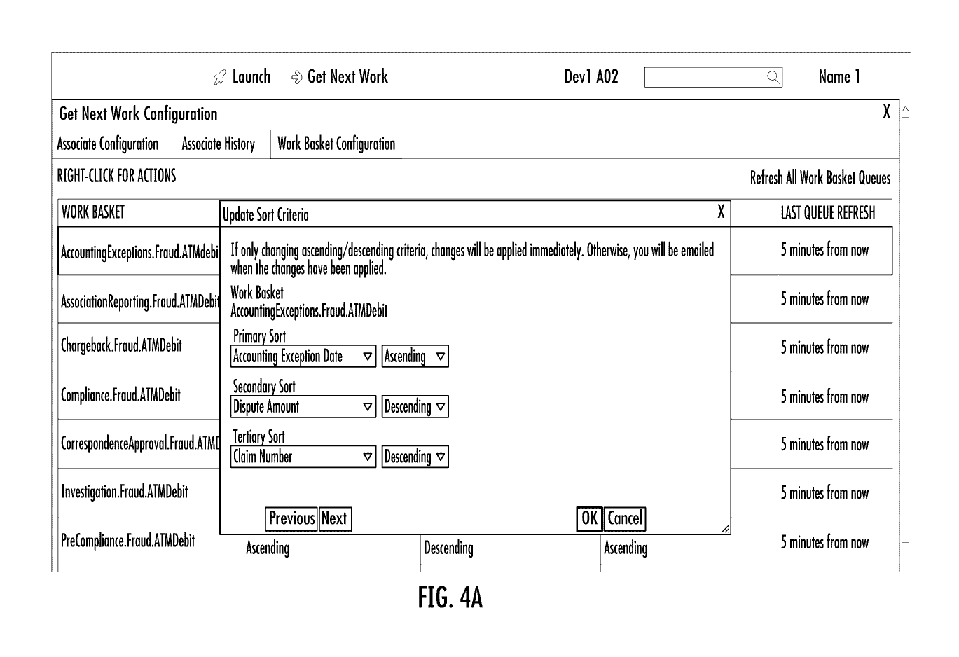

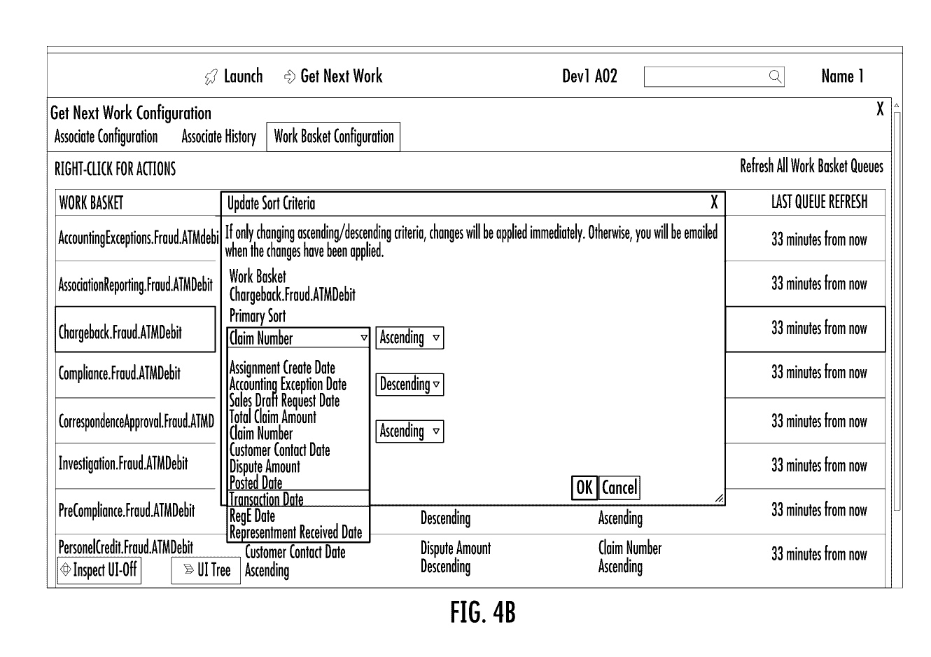

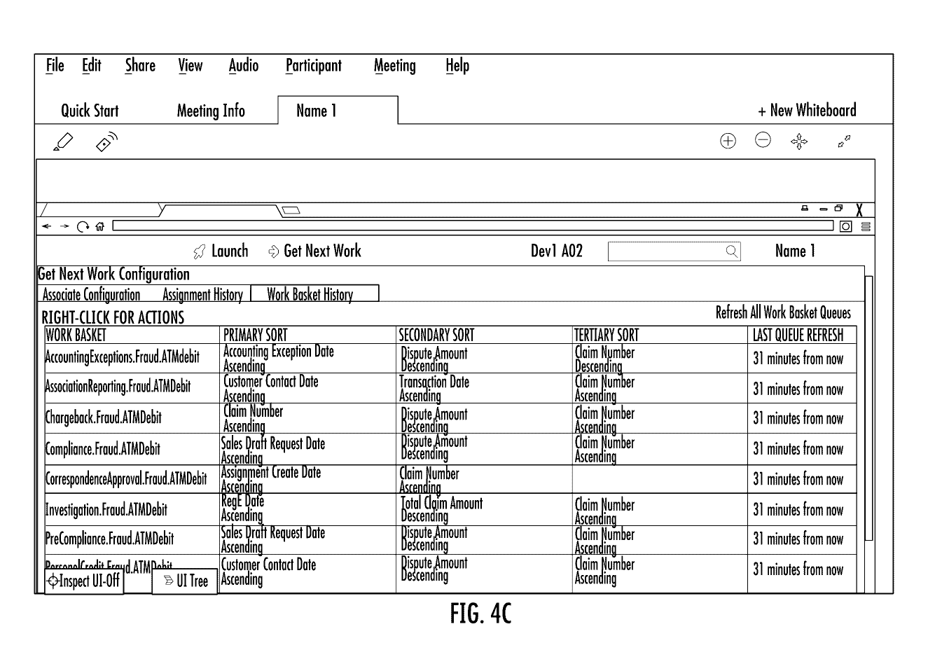

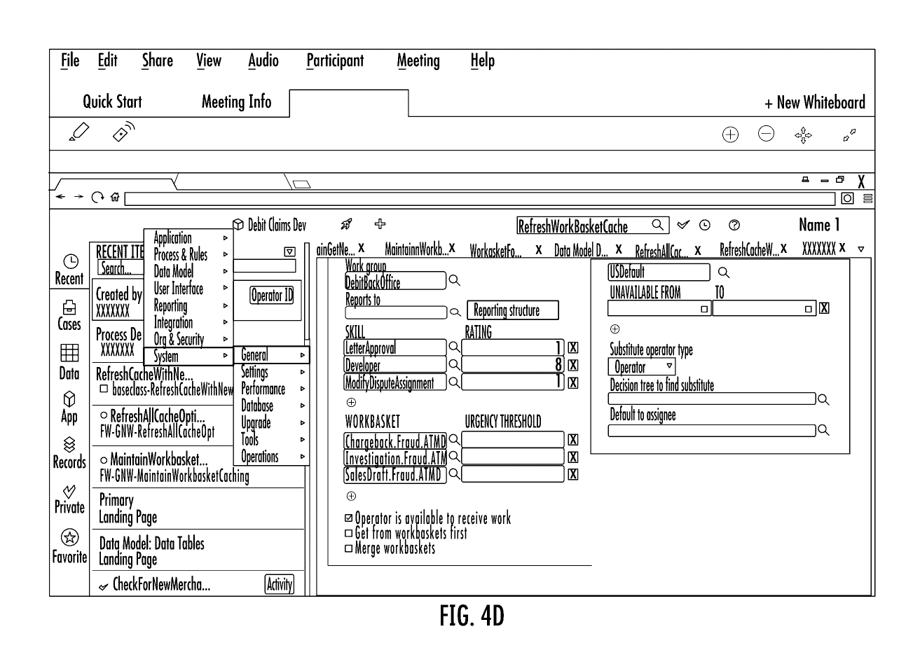

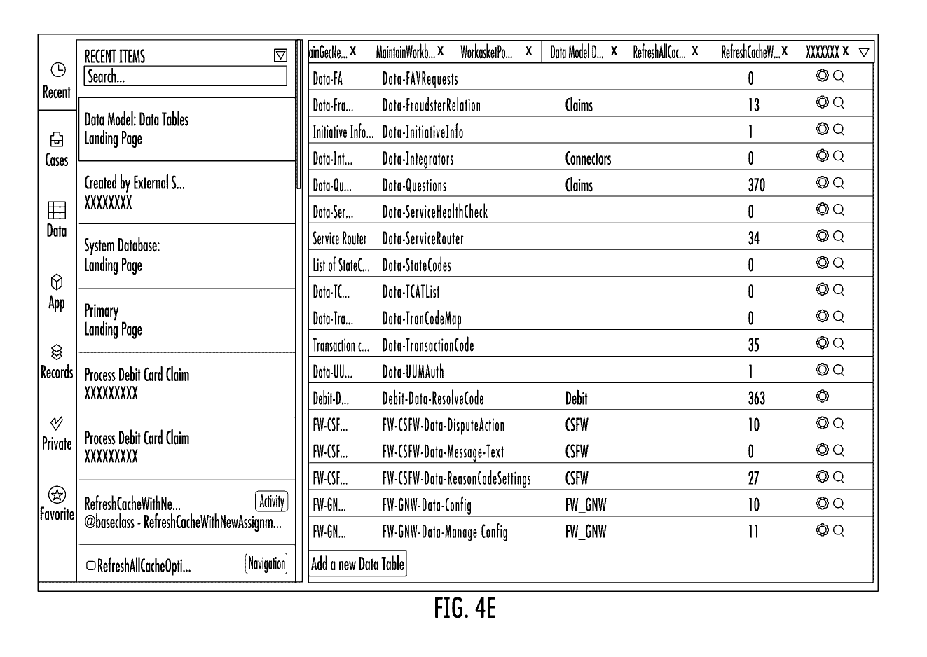

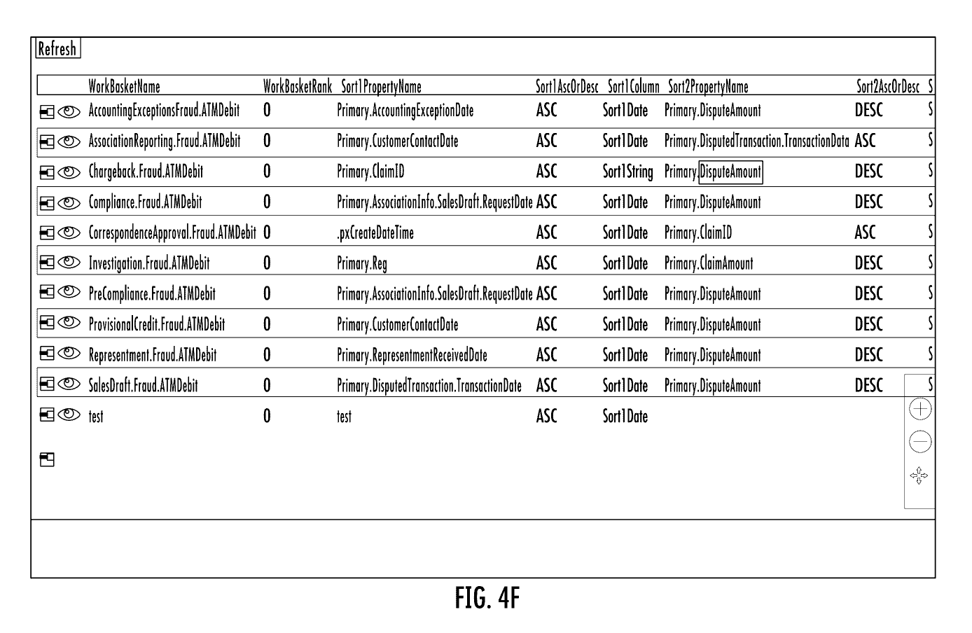

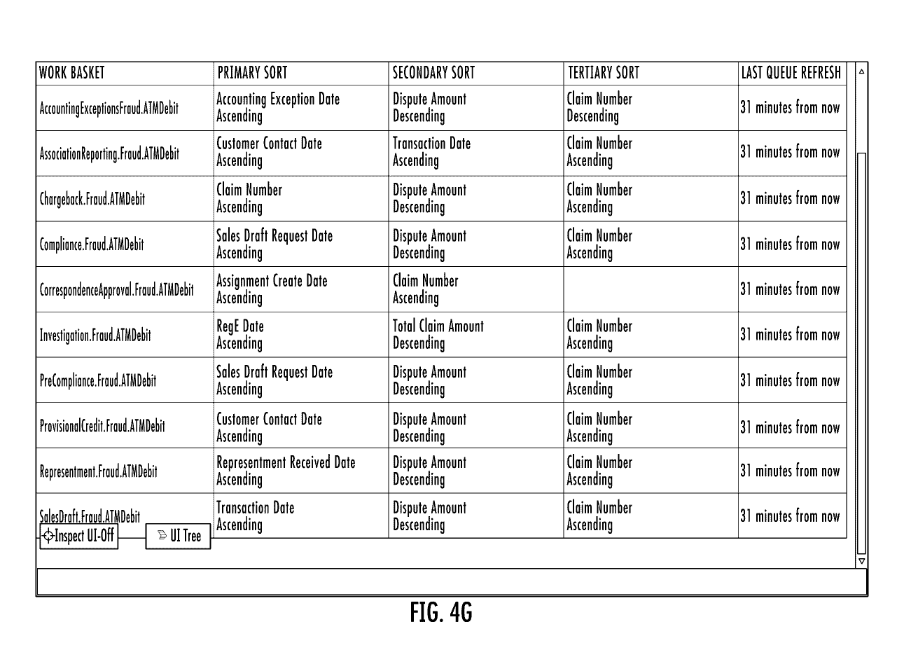

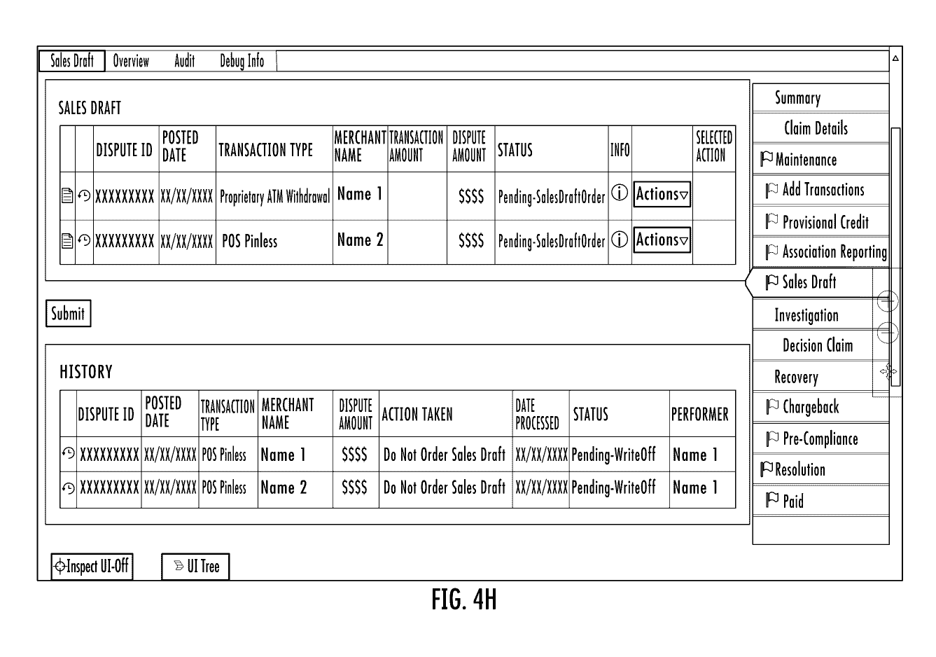

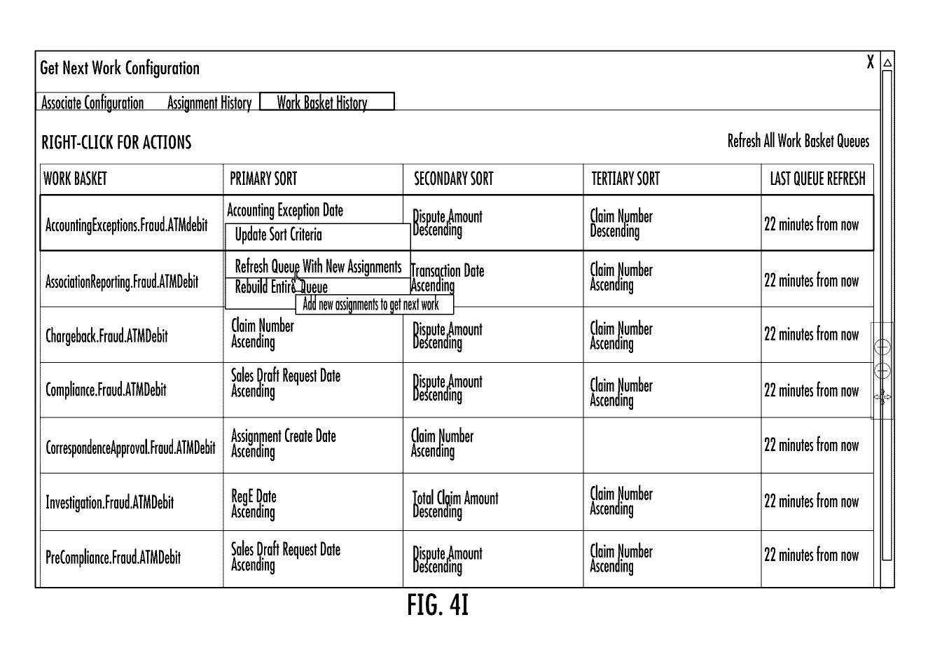

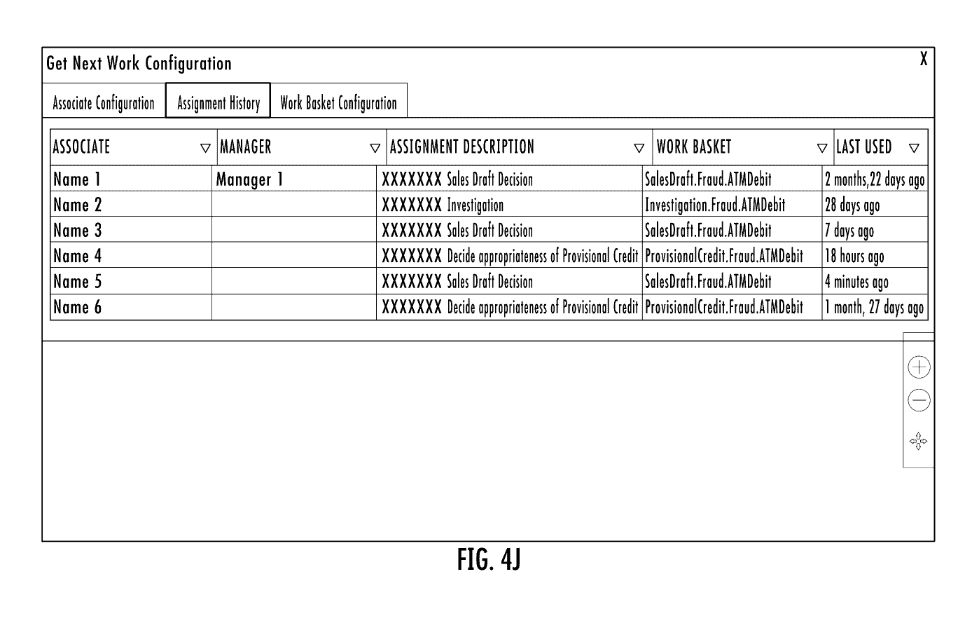

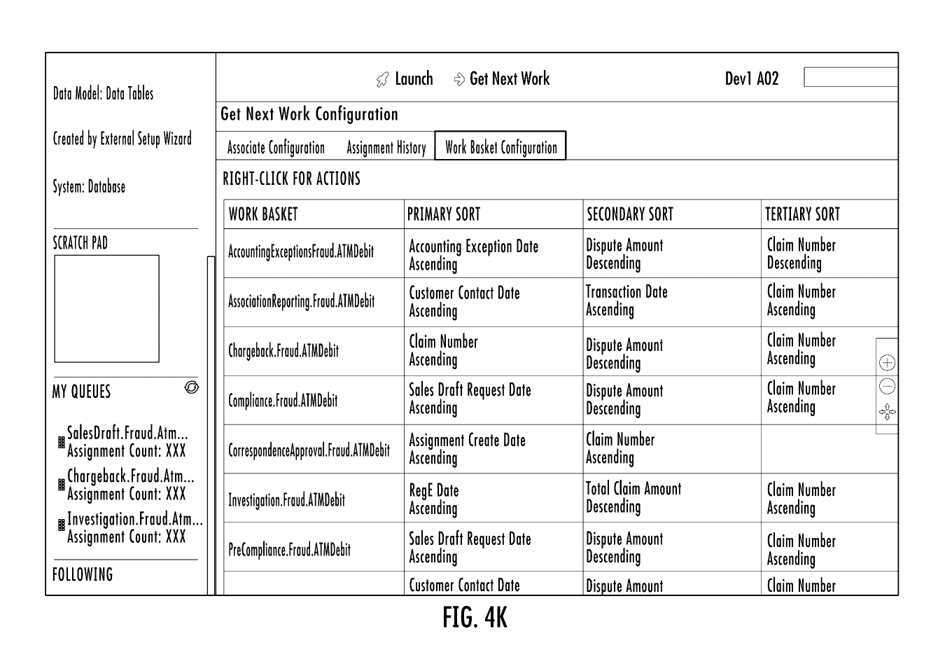

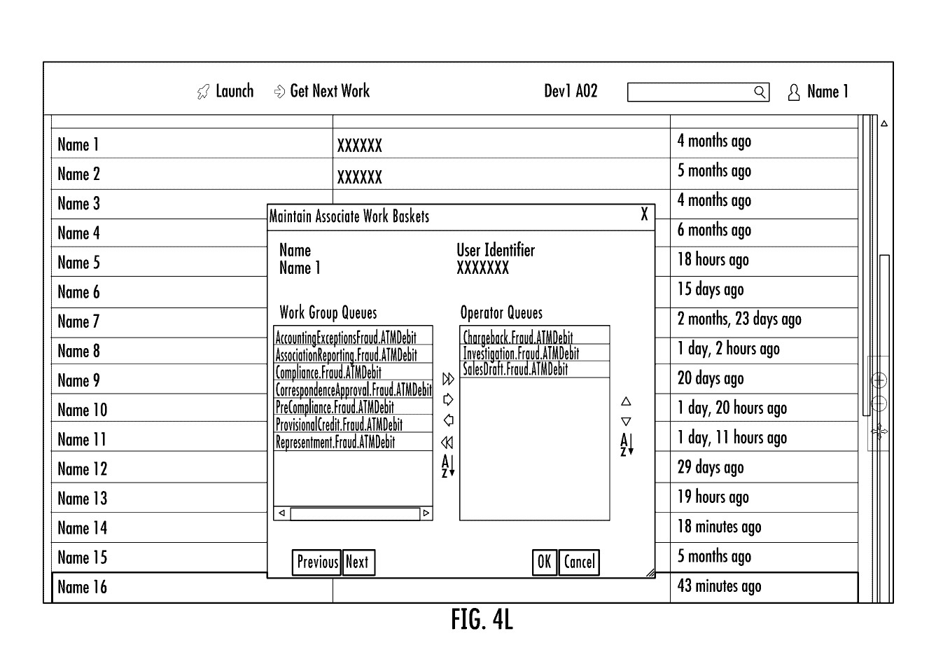

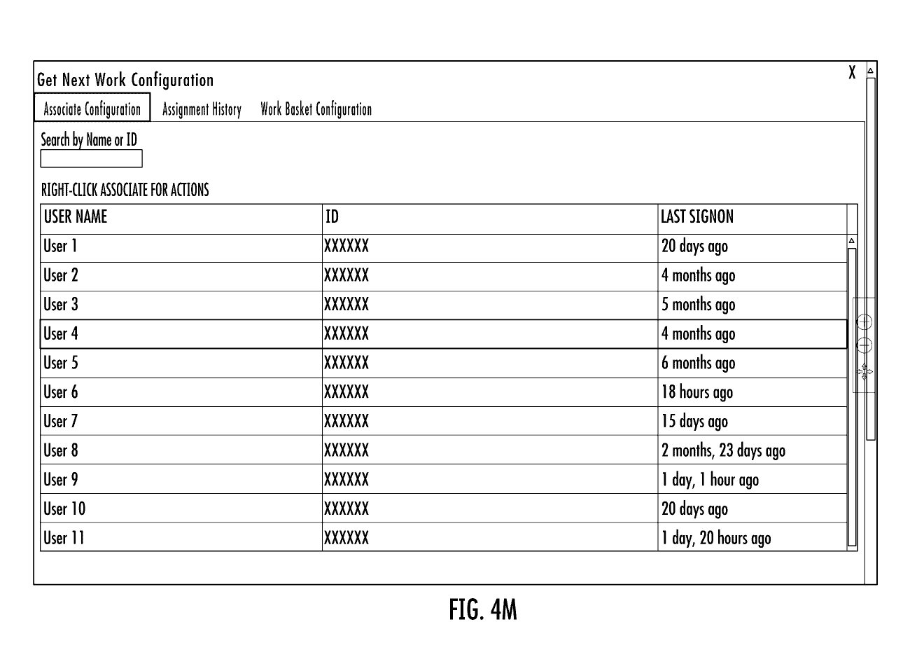

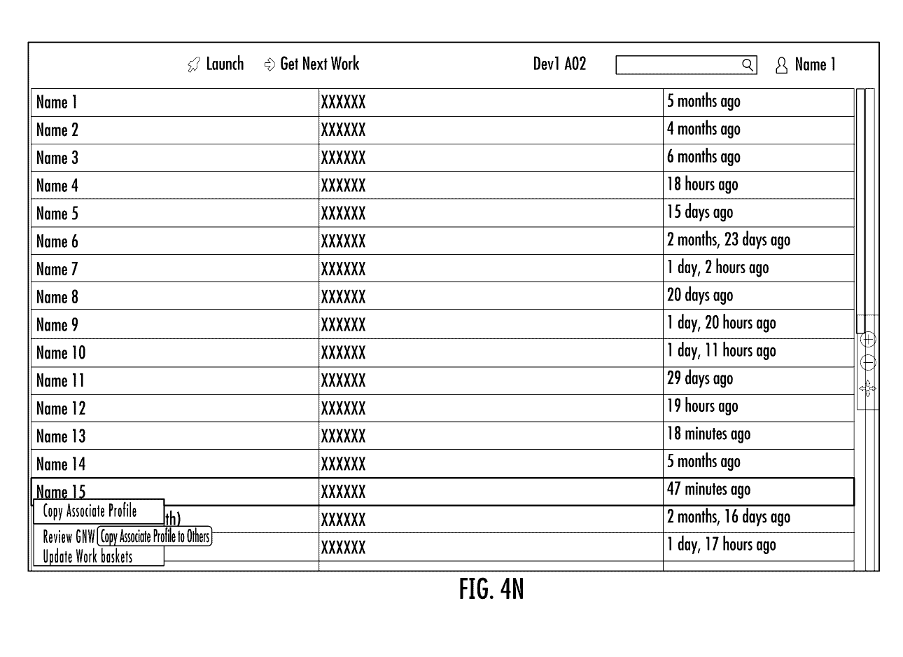

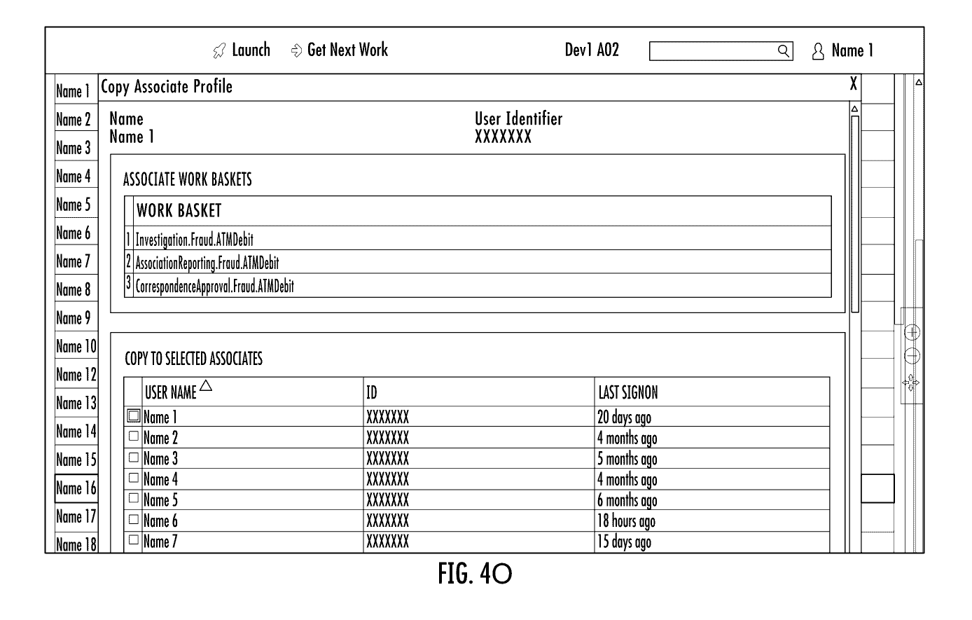

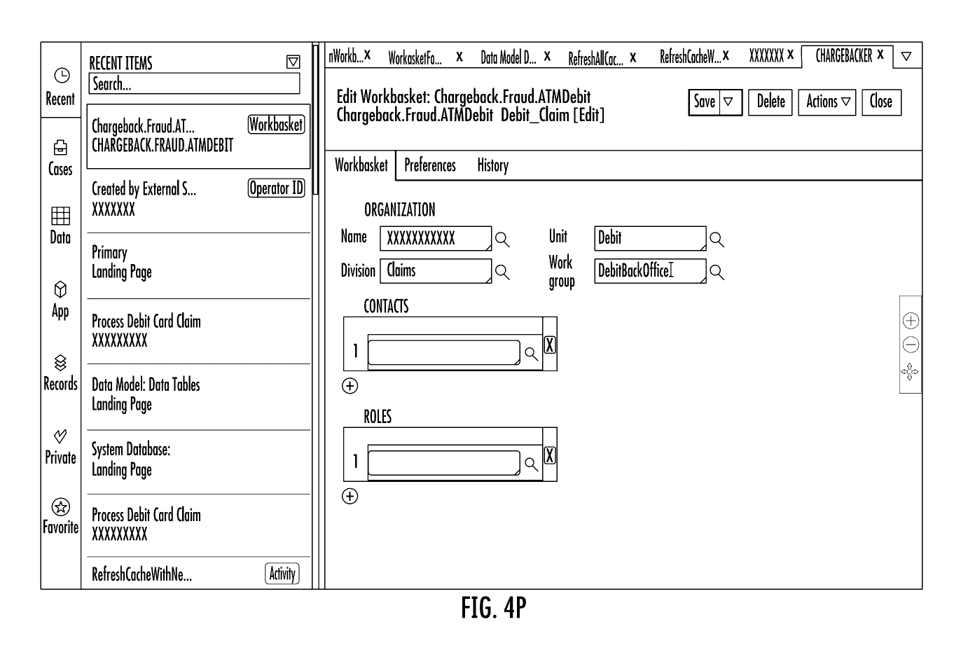

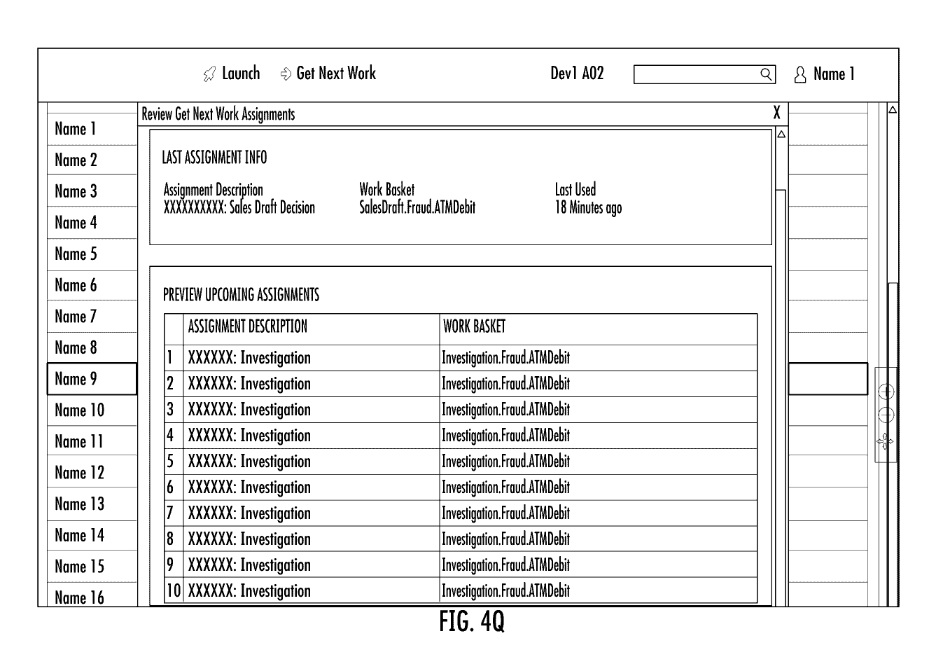

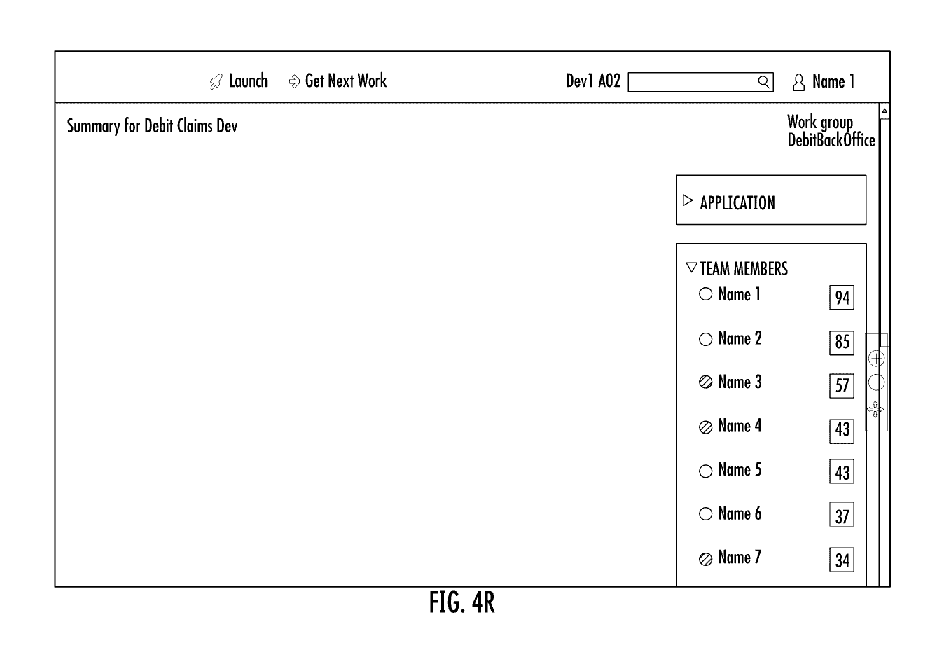

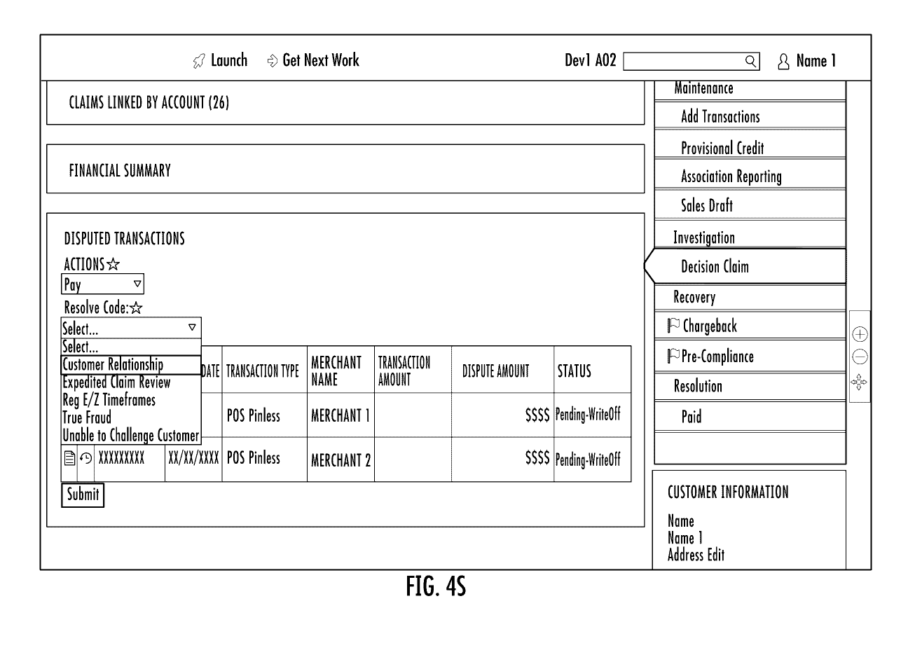

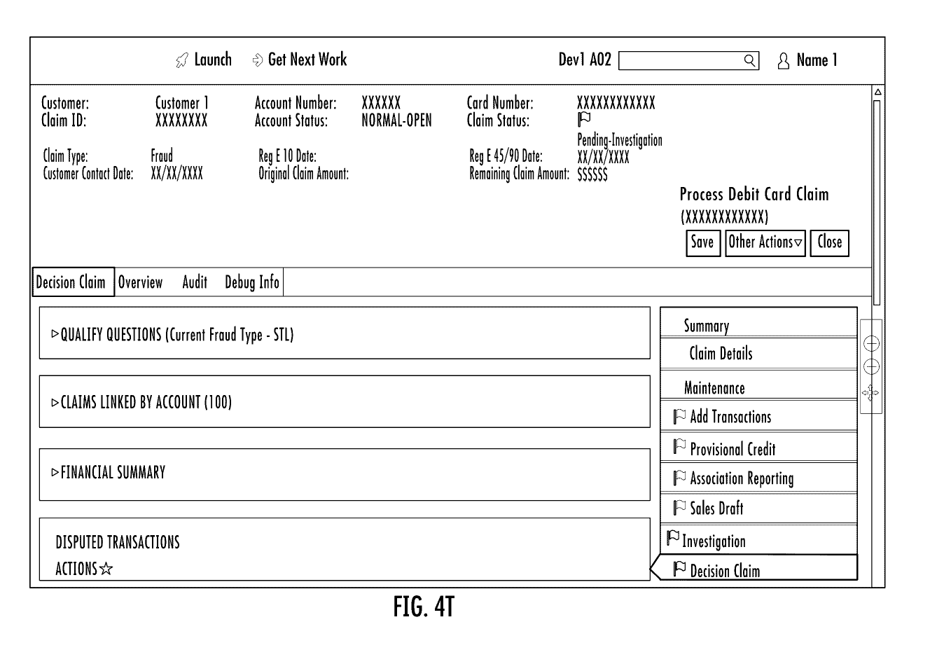

Referring to FIGS. 4A-4T, representations of screenshots of a user interface running on a user system are illustrated according to embodiments of the invention. In FIGS. 4A and 4B, screenshots of a manager interface enabling creation of a cache table from a main assignment table are shown. In some embodiments, the cache tables are used for work allocation as discussed herein, and in some embodiments, the system also creates and utilizes middle tables, i.e., tables virtually between the main assignment table and the cache tables. The middle tables are configured to enable managers to configure manager options, which can be stored and retrieved by the system as necessary. FIG. 4B shows a dropdown menu enabling the manager to update the primary sort options.

In FIG. 4C, a screenshot of the interface for work basket configuration is shown. This interface enables a manager to sort work based on primary, secondary and tertiary considerations.

Referring to FIG. 4D, a manager's menu for configuring an associate's assigned work baskets is illustrated.

In FIG. 4E, an interface for enabling configuration of data sources for the system is illustrated. For example, the two tables at the bottom of the illustrated figure are relevant to the get next work (GNW) functionality discussed herein, which enables an associate, upon completion of a task, to select GNW and, based on the claims cache tables and allocation rules, the systems gets the associate's next work to complete.

In FIG. 4F, a manager interface for configuring data tables, such as the claims cache tables, used by the system is shown.

In FIG. 4G, an interface for adding new data tables, such as new claims cache tables, for use by the system is shown.

FIG. 4H is a screenshot of a claim summary interface of an associate who has assigned work.

FIG. 4I is a screenshot of a manager interface showing refresh queue functionality. Such a refresh queue allows for any new assignments and/or records to be reflected. In some instances, a manager wishes to rebuild the entire world of workflow, which reviews all work assignments and reorganizes them as necessary based on any changes to claims cache tables or otherwise.

FIG. 4J is a screenshot of a manger interface showing assignments of work to associates in the manager's group. This is, in other words, a report of assignment history for a workgroup (of a manager) and provides information regarding various work baskets assigned to the workgroup.

FIG. 4K is a screenshot of an associate interface showing associate queues, specifically showing the “My Queues” toolbox on the left-hand side of the interface. The My Queues toolbox shows the work assigned to each associate.

FIG. 4L is a screenshot of a manager's interface for sorting work group queues and operator queues. On the left-hand side are those work group queues that are available for sorting, and on the right-hand side are those work baskets assigned to a particular operator (aka associate).

FIG. 4M is a screenshot of an associate configuration page of a manager interface, which lists all the associates on a manager's team (aka workgroup or group).

FIG. 4N is a screenshot of a manager interface showing work manipulation functionality such as copying of associate profile functionality, and FIG. 4O is a screenshot showing more detail of the copy associate work basket functionality.

FIG. 4P is a screenshot showing a manager interface enabling modifying a work basket (i.e., a work profile).

FIG. 4Q is a screenshot of a manager interface for reviewing get next work (GNW) assignments. Such GNW assignments operate to cause an associate to be assigned a particular project (i.e., work) when the associate selects a GNW option on his or her associate interface.

FIG. 4R is a screenshot of a manager interface for showing team members of a group and their respectively assigned work or claims.

FIG. 4S is a screenshot of a customer-centric claims summary page of an associate's interface. When the associate selects the “Get Next Work” (GNW) option at the top of the interface, an investigation screen may be opened for the particular work (or claim) as shown in FIG. 4S.

FIG. 4T shows a claim-centric summary page of a processed claim.

Thus, systems, apparatus, methods, and computer program products described above provide for a centralized system for claims workflow management. The centralized aspect of the system provides the ability to manage all of the workflows existing throughout a large enterprise regardless of the format of the workflow platform/system providing the workflows. Embodiments of the invention provide a claims work management system that intakes claims being of different types and priority for processing. Integrated with the system are work management tools to prioritize and allocate work to various groups and users. The system creates different cache tables based on profiles of the work for assignment to groups and users. The cache tables may be generated from the overall claims database and then assigned based on work allocation rules to groups and individual users. The cache data tables may be static or updated on request to ensure prioritized claims are processed with little to no latency. The system allows for on-demand work allocations and dashboards regarding claims processing.

In some cases, embodiments of the system allow for creation of group and user profiles and designation of claim types to the groups and individual users. During operation, the system allows managers to reassign/prioritize claim types for processing by individual groups or users dynamically during claims processing. Embodiments of the system herein described provides for existing workflows to be changed/edited, new workflows added or obsolete workflows deleted) and, as a result of such changes/additions/deletions, automatically adapt all downstream and upstream workflows that are affected by the change or addition.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for claims work management by claims caching and dynamic work allocation, the system comprising:
a computing platform having a memory and at least one processor in communication with the memory;
a plurality of claims input channels each configured to communicate one or more of a plurality of claims of varying types and priorities;
a centralized claims work management module stored in the memory, executable by the processor, and configured to cause the processor to:
receive the plurality of claims from the plurality of claims input channels;
determine the type and priority of each of the received plurality of claims;
determine a profile of work for one or more claims based on the determined type and priority of each of the one or more claims;
create a plurality of claims cache tables based on the profiles of work, each cache table comprising one or more of the plurality of claims; and
in automatic response to determining the profile of work for the one or more claims, dynamically allocating each of the plurality of claims to at least one group and at least one user within the at least one group.

2. The system of claim 1, wherein dynamically allocating each of the plurality of claims comprises assigning each cache table and its one or more claims to at least one group and at least one user within the at least one group.

3. The system of claim 1, wherein the centralized claims work management module is further configured to cause the processor to:
access one or more work allocation rules; and
wherein dynamically allocating is based at least in part on the accessed work allocation rules.

4. The system of claim 1, wherein the centralized claims work management module is further configured to cause the processor to:
receive a request from a user to update one or more of the claims cache tables;
in response to receiving the request, updating the claims cache tables, thereby resulting in one or more prioritized claims being processed with little or no latency.

5. The system of claim 1, wherein the centralized claims work management module is further configured to cause the processor to:
lock one or more of the claims cache tables so that no modifications of the claims in the one or more claims cache tables is allowed.

6. The system of claim 1, wherein the centralized claims work management module is further configured to cause the processor to:
lock assignment of at least one of the claims cache tables to (1) its assigned at least one group, or (2) its assigned at least one user.

7. The system of claim 1, wherein the centralized claims work management module is further configured to cause the processor to:
cause presentation of a manager interface comprising a queue of workflow management with drag and drop functionality.

8. The system of claim 7, wherein the manager interface is configured to enable a manager of claims work to reallocate, in real-time, one or more of the allocated plurality of claims.

9. The system of claim 7, wherein:
the manager interface is configured to enable a manager of claims work to change (1) a priority associated with one or more claims, or (2) a priority associated with one or more profiles of work; and
the centralized claims work management module is further configured to cause the processor to dynamically reallocate, in automatic response to the manager interface receiving manager input changing (1) a priority associated with one or more claims, or (2) a priority associated with one or more profiles of work, one or more of the allocated plurality of claims based at least in part on the manager input.

10. A method for claims work management by claims caching and dynamic work allocation, the method comprising:
receiving, by a processor of a computing platform executing a centralized claims work management module stored in a memory of the computing platform, a plurality of claims from a plurality of claims input channels each configured to communicate one or more of the plurality of claims of varying types and priorities;
determining, by the processor executing the centralized claims work management module, the type and priority of each of the received plurality of claims;
determining, by the processor executing the centralized claims work management module, a profile of work for one or more claims based on the determined type and priority of each of the one or more claims;
creating, by the processor executing the centralized claims work management module, a plurality of claims cache tables based on the profiles of work, each cache table comprising one or more of the plurality of claims; and
in automatic response to determining the profile of work for the one or more claims, dynamically allocating, by the processor executing the centralized claims work management module, each of the plurality of claims to at least one group and at least one user within the at least one group.

11. The method of claim 10, wherein dynamically allocating each of the plurality of claims comprises assigning each cache table and its one or more claims to at least one group and at least one user within the at least one group.

12. The method of claim 10, further comprising:
accessing, by the processor executing the centralized claims work management module, one or more work allocation rules; and
wherein dynamically allocating is based at least in part on the accessed work allocation rules.

13. The method of claim 11, further comprising:
receiving a request from a user to update one or more of the claims cache tables; and
in response to receiving the request, updating the claims cache tables, thereby resulting in one or more prioritized claims being processed with little or no latency.

14. The method of claim 11, further comprising:
locking, by the processor executing the centralized claims work management module, one or more of the claims cache tables so that no modifications of the claims in the one or more claims cache tables is allowed.

15. The method of claim 11, further comprising:
locking, by the processor executing the centralized claims work management module, assignment of at least one of the claims cache tables to (1) its assigned at least one group, or (2) its assigned at least one user.

16. The method of claim 10, further comprising:
causing presentation, by the processor executing the centralized claims work management module, of a manager interface comprising a queue of workflow management with drag and drop functionality.

17. The method of claim 16, wherein the manager interface is configured to enable a manager of claims work to reallocate, in real-time, one or more of the allocated plurality of claims.

18. The method of claim 16, wherein:
the manager interface is configured to enable a manager of claims work to change (1) a priority associated with one or more claims, or (2) a priority associated with one or more profiles of work; the method further comprising:
dynamically reallocating, by the processor executing the centralized claims work management module and in automatic response to the manager interface receiving manager input changing (1) a priority associated with one or more claims, or (2) a priority associated with one or more profiles of work, one or more of the allocated plurality of claims based at least in part on the manager input.

19. A computer program product for claims work management by claims caching and dynamic work allocation, the computer program product comprising:
a non-transitory computer-readable medium comprising:
a first set of codes for causing a computer to receive a plurality of claims from the a plurality of claims input channels;
a second set of codes for causing a computer to determine the type and priority of each of the received plurality of claims;
a third set of codes for causing a computer to determine a profile of work for one or more claims based on the determined type and priority of each of the one or more claims;
a fourth set of codes for causing a computer to create a plurality of claims cache tables based on the profiles of work, each cache table comprising one or more of the plurality of claims; and
a fifth set of codes for causing a computer to, in automatic response to determining the profile of work for the one or more claims, dynamically allocate each of the plurality of claims to at least one group and at least one user within the at least one group.
